(19) United States
(12) Patent Application Publication
(10) Pub. No.: US 2006/0090303 A1
(43) Pub. Date: May 4, 2006

(54) Fasteners

(76) Inventor: Simon Woollard, Haslemere, Surrey (GB)

Correspondence Address: KENYON & KENYON LLP, ONE BROADWAY, NEW YORK, NY, 10004, US

(21) Appl. No.: 10/527,283

(22) PCT Filed: Sep. 5, 2003
(86) PCT No.: PCT/GB03/03832

§ 371 Date: Oct. 4, 2005

(30) Foreign Application Priority Data
Sep. 9, 2002 (GB) 0220878.3

(51) Int. Cl. B42F 1/00

(52) U.S. Cl. 24/67 AR

(57) ABSTRACT

A fastener (1) for holding together a group (7) of documents comprises a foldable sheet of, for example, paper divided into at least one anchor portion (2) and at least one tab portion (3, 4). Attachment means such as repositional adhesive provide for attachment of those portions to at least the first and last documents of the group upon being folded around an edge of the group. To assist with this, the sheet is marked with at least one fold line to be aligned with at least one edge of the group upon attachment of the anchor portion to the first document in the group, prior to folding the tab portion around that edge of the group for attachment to the last document in the group. Preferred embodiments employ two mutually orthogonal fold lines that intersect at or outside the periphery of the fastener sheet.

This invention relates to fasteners, particularly fasteners for fastening together sheets of paper, card or like materials. For brevity, sheets of paper, card or like materials will be referred to collectively herein as sheets of paper or simply as documents.

Conventionally, when sheets of paper are gathered into a group, they are held together by fasteners such as staples, paper clips or other paper-gripping or paper-engaging means such as spring clips or studs. Whilst each known type of fastener solves some problems and so has its own advantages, it suffers from or creates other problems. This leaves a need for an alternative fastener that avoids or mitigates such disadvantages.

For example, many known fasteners require special application and/or removal tools, such as a stapler and a staple remover required for staples. It is a disadvantage for a fastener to require the use of such tools because the tools have to be stored, maintained and loaded, and of course they involve additional cost which may be far beyond the cost of the fasteners themselves. However, the use of such tools may be essential, or at least highly advantageous, to apply or remove certain fasteners.

Moreover, many fasteners are destructive in that they involve puncturing, creasing, tearing or otherwise marking the sheets of paper they hold together, either upon application or upon removal. This damage frequently makes the sheets unsuitable for re-use. Some fasteners themselves may also be damaged by use and removal and so are suitable for one use only, being discarded thereafter and requiring application of a replacement. This represents a waste of time and money, especially if a fastened group of papers needs only to be separated temporarily, for example for the removal or addition of one sheet. Also, known fasteners can damage equipment such as photocopiers, scanners or fax machines if they are inadvertently left on a sheet of paper or on a group of such sheets when copying, scanning or faxing.

Other, nominally non-destructive and reusable fasteners exemplified by paper clips do not hold together sheets of paper securely enough for many purposes, and may also be damaged by use. For example, a paper clip tends to stretch or deform plastically to the extent that it no longer grips elastically; also, its protruding shape means that it is prone to being snagged and knocked off the group of papers that it is supposed to fasten together.

A further problem is that many fasteners have substantial thickness and weight in the context of the relatively thin and light papers they hold together. Increased weight tends to increase mailing charges. Also, as a staple can add more than 1 mm and a paper clip more than 2 mm to the thickness of a fastened group of papers, this militates against compact, flat storage of several groups of fastened papers. Indeed, as fasteners increase the local thickness of a stack of groups in proportion to the number of groups and hence fasteners, this requires fastened papers to be stacked with care. Otherwise, the stack might topple due to the fasteners being all on one side of the stack and hence tending to tilt the stack further away from the vertical as it gets higher. Similar problems can afflict fastened groups mailed in an envelope or placed in a filing cabinet, which can lead to inefficient filing and the potential for additional mail charges.

Safety is also a concern with many fasteners. The fasteners themselves tend to be small and so present choking hazards to the very young, and they tend to have sharp edges or points that introduce a risk of injury to all users but especially to children and the elderly. Where tools are needed to apply or remove fasteners, the risk of injury extends to the use of such tools.

It is against this background that the present invention has been devised. Put broadly, the invention contemplates a fastener for holding together a group of documents, the fastener comprising a foldable sheet of, for example, paper divided into at least one anchor portion and at least one tab portion. Attachment means provide for attachment of those portions to at least the first and last documents of the group upon being folded around an edge of the group. To assist with this, the sheet is marked with at least one fold line to be aligned with at least one edge of the group upon attachment of the anchor portion to the first document in the group, prior to folding the tab portion around that edge of the group for attachment to the last document in the group.

Whilst other attachment means such as magnetism and electrostatics will be discussed, it is much preferred that the attachment means comprises repositional adhesive. That adhesive is suitably applied as a layer on one side of the sheet but a minor edge portion of that side of the sheet may be left non-adhesive as a lifting tab to assist with application, removal and repositioning of the fastener.

Preferably, the anchor portion and the tab portion are distinguished by different shading or colouring. Further or in the alternative, a mutual boundary between the anchor portion and the tab portion can be marked by a printed line, a line of perforations or a crease line which can be a single crease line or a plurality of creases separated by one or more bands. Where a crease line is employed, a relatively strong adhesive can extend along and across the crease line to adhere to the edges of grouped documents.

Currently preferred embodiments of the invention employ first and second fold lines that divide the sheet into a central anchor portion and first and second outer tab portions foldable around mutually orthogonal edges at a corner of the grouped documents. For a neat and secure finish, the tab portions can substantially abut upon being attached to the last document of the group after folding. Most preferably, the first and second fold lines are mutually orthogonal to suit folding around the mutually orthogonal edges of the grouped documents.

In order to enable a plurality of sheets to be held more firmly in a group, at least one of the outer tab portions may be divided into two of more segments, each of which is foldable around one of the mutually orthogonal edges of the group for attachment to a respective document of the group.

The first and second fold lines may intersect at an edge of the sheet or extensions of the first and second fold lines may intersect outside the periphery of the sheet. A notch may extend inwardly from the edge of the sheet in the region of said intersection, to allow for some misalignment upon folding.

Whilst many different shapes can be adopted for the sheet within the inventive concept, most embodiments of the invention employ an oblong sheet. In that case, the ratio of long edges to short edges of the oblong is preferably 2:1. Moreover, it is preferred that the fold lines divide the sheet into a central triangular anchor portion flanked by two outer triangular tab portions inverted with respect to the central triangular anchor portion. In that event, when the tab portions substantially abut upon being attached to the last document of the group, they can cooperate to form a triangle on the reverse of the last document corresponding to the central triangular anchor portion attached to the first document of the group.

The fastener of the invention can bear graphical matter or indicia divided into components borne by respective ones of first and second tab portions, so that when the tab portions are attached to the last document of the group, those components are united to be viewed together.

The inventive concept extends to a pad of fasteners as defined herein in accordance with the invention.

According to a second aspect of the invention, there is provided a method of fastening a group of documents, the method comprising: aligning the first and second fold lines of a fastener with the edges of the first document of the group in the corner to be fastened; attaching the anchor portion to said first document; adding a second document to the group in alignment with the first document; folding a first tab portion of the fastener around an associated edge of the group and attaching that tab portion to the second document; adding a third document to the group in alignment with the first and second documents and folding a second tab portion of the fastener around an associated edge of the group and attaching that tab portion to the third document.

In order that the invention can be more readily understood, reference will now be made by way of example to the accompanying drawings in which:

FIG. 1 is a front or top view of a fastener in accordance with a preferred embodiment of the invention;

FIG. 2 is a rear or bottom view of the fastener of FIG. 1;

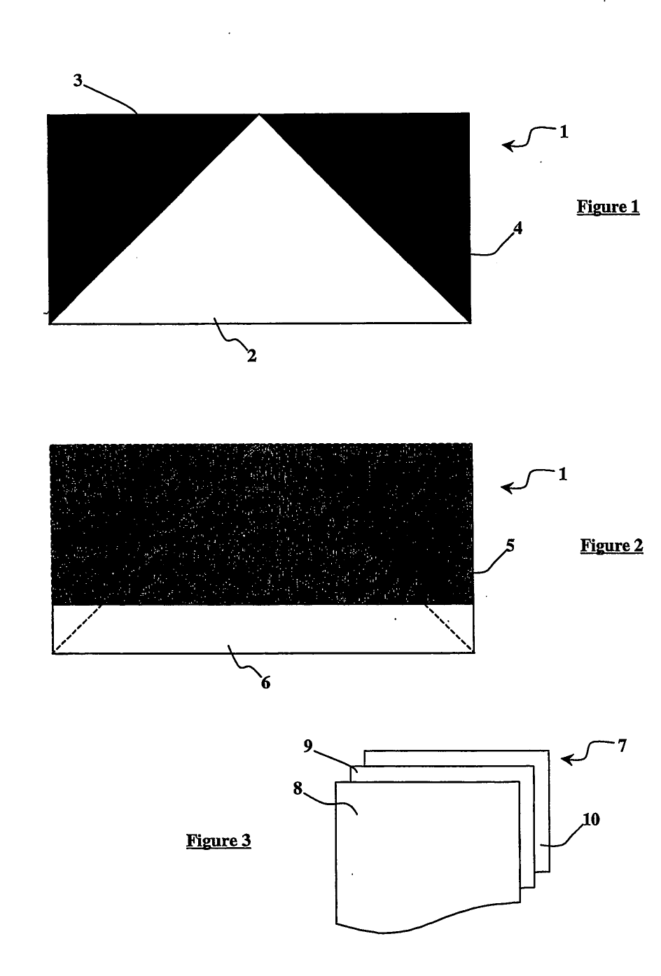

FIG. 3 shows papers being gathered together into a group for application of the fastener of FIGS. 1 and 2;

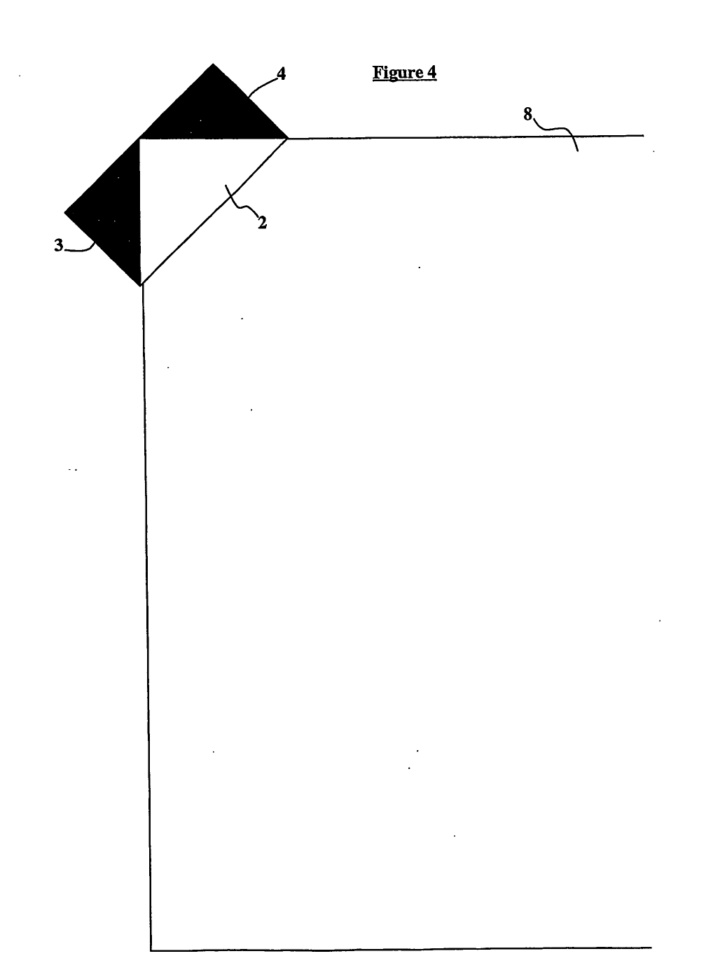

FIG. 4 is a front or top view that follows on from FIG. 3 and shows the fastener applied to a corner of the uppermost sheet of the group, before being folded;

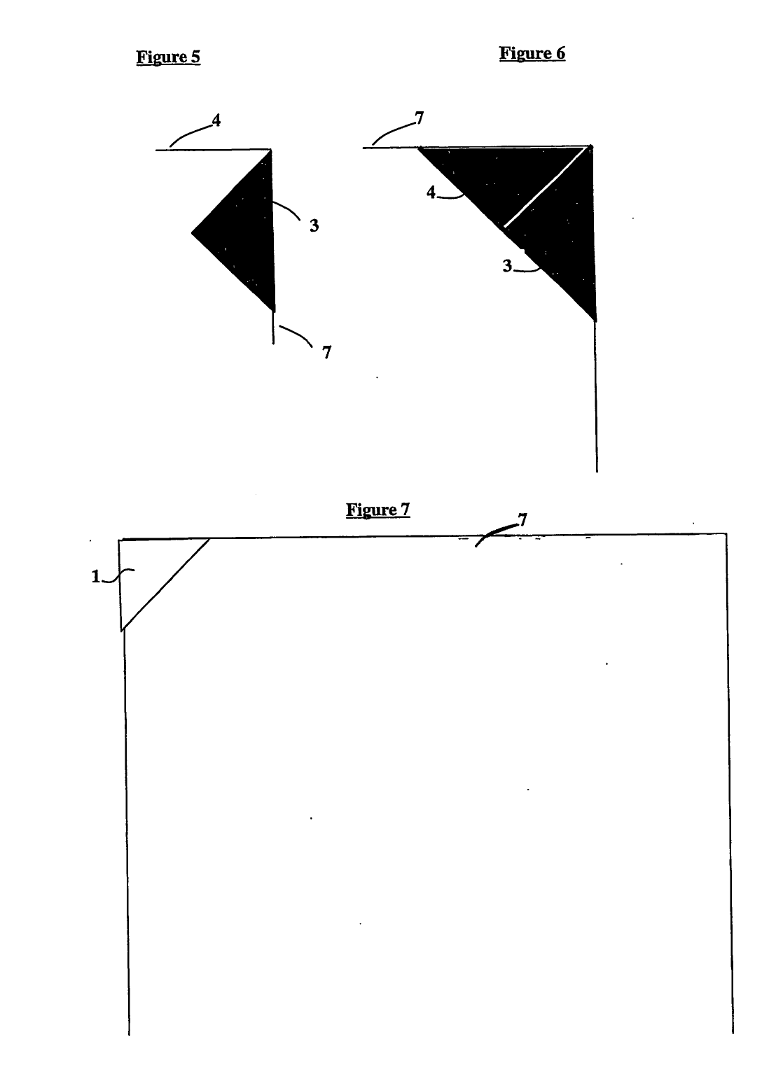

FIG. 5 is a side view following on from FIG. 4 that shows the smaller triangular tab portions of the fastener being folded behind the lowermost sheet of the group;

FIG. 6 is a reverse view that shows the fastener applied to the uppermost sheet of the group;

FIG. 7 is a front view of the group of sheets held together by the fastener in accordance with FIGS. 1 to 6;

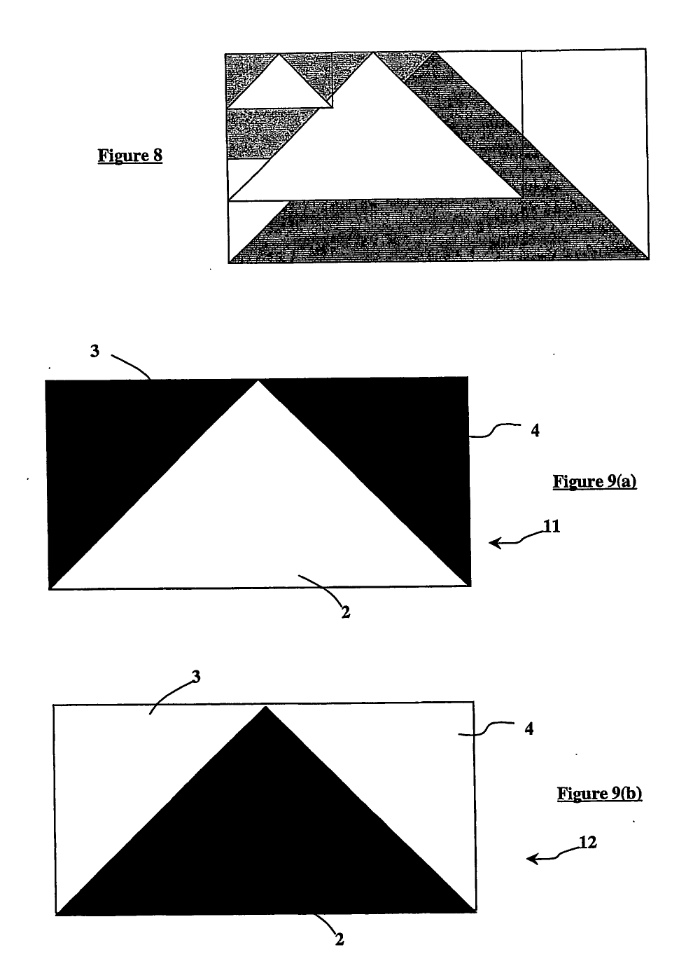

FIG. 8 is a front view of different fastener sizes shown superimposed on one another for the purpose of comparison;

FIGS. 9(a) and 9(b) are front views of a fastener that contrast different shading or colouring possibilities;

FIG. 10 is a front view of a fastener in which fold lines are marked by lines of perforations;

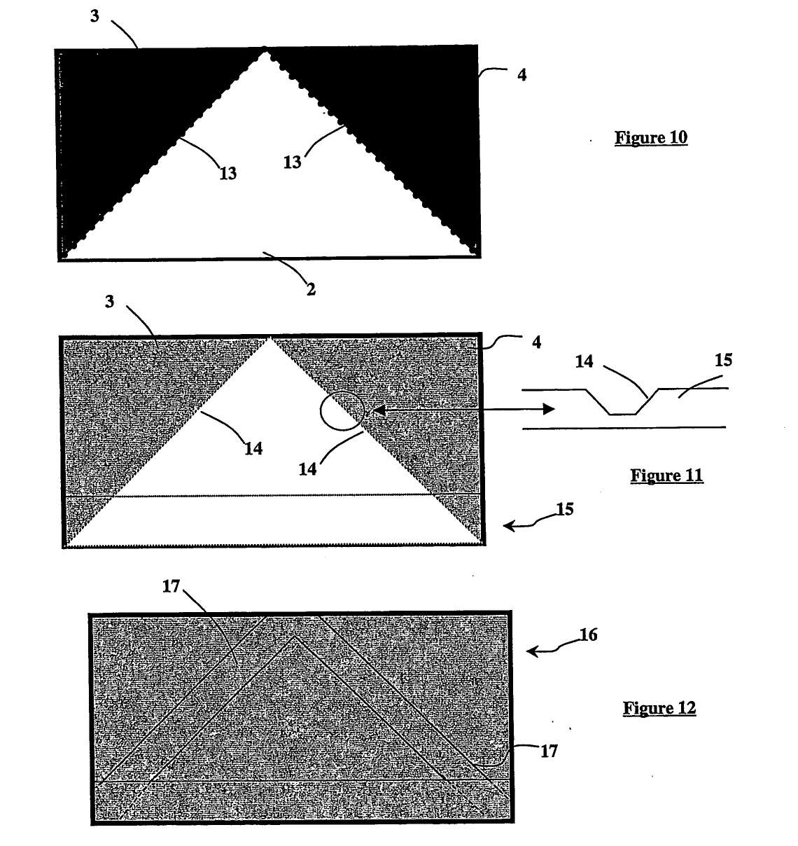

FIG. 11 is a front view of a fastener in which fold lines are marked by crease lines;

FIG. 12 is a front view of a fastener in which wide crease lines bear bands of relatively strong adhesive;

FIG. 13 is a front view of a fastener in which a notch extends inwardly from the edge of the sheet in the region of the intersection between fold lines;

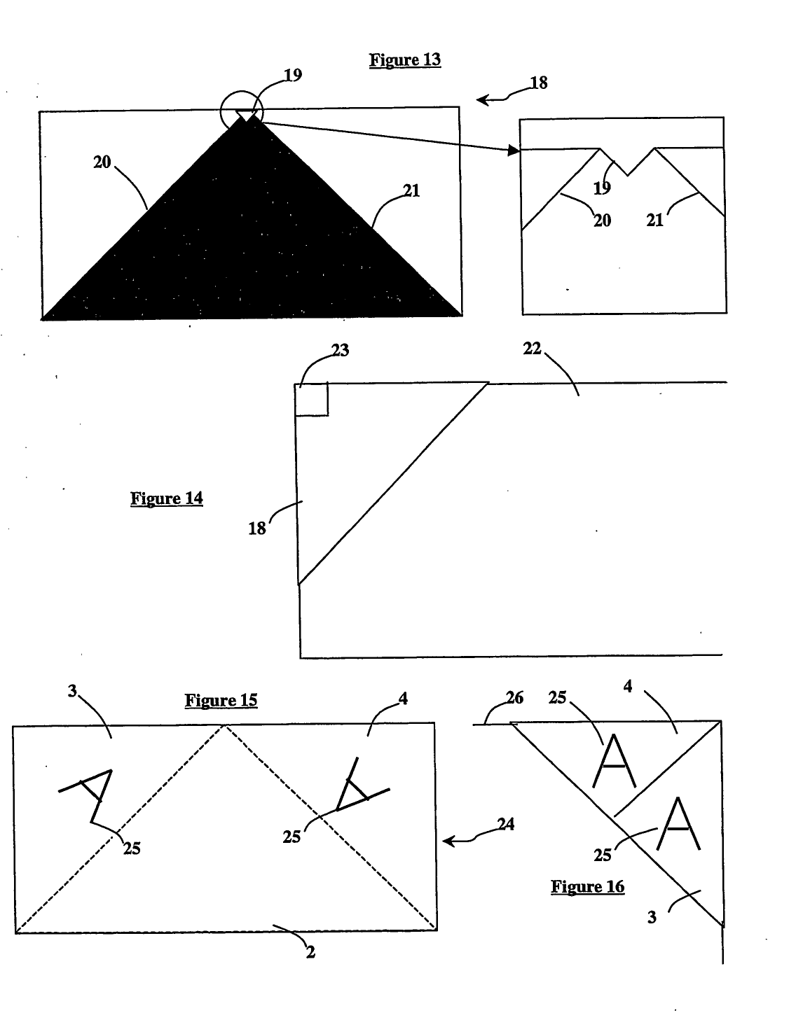

FIG. 14 is a front view of the fastener of FIG. 13, in use fastening together a group of sheets;

FIG. 15 is a front view of a fastener bearing indicia components on each outer tab portion;

FIG. 16 is a reverse view of the fastener of FIG. 15, in use fastening together a group of sheets;

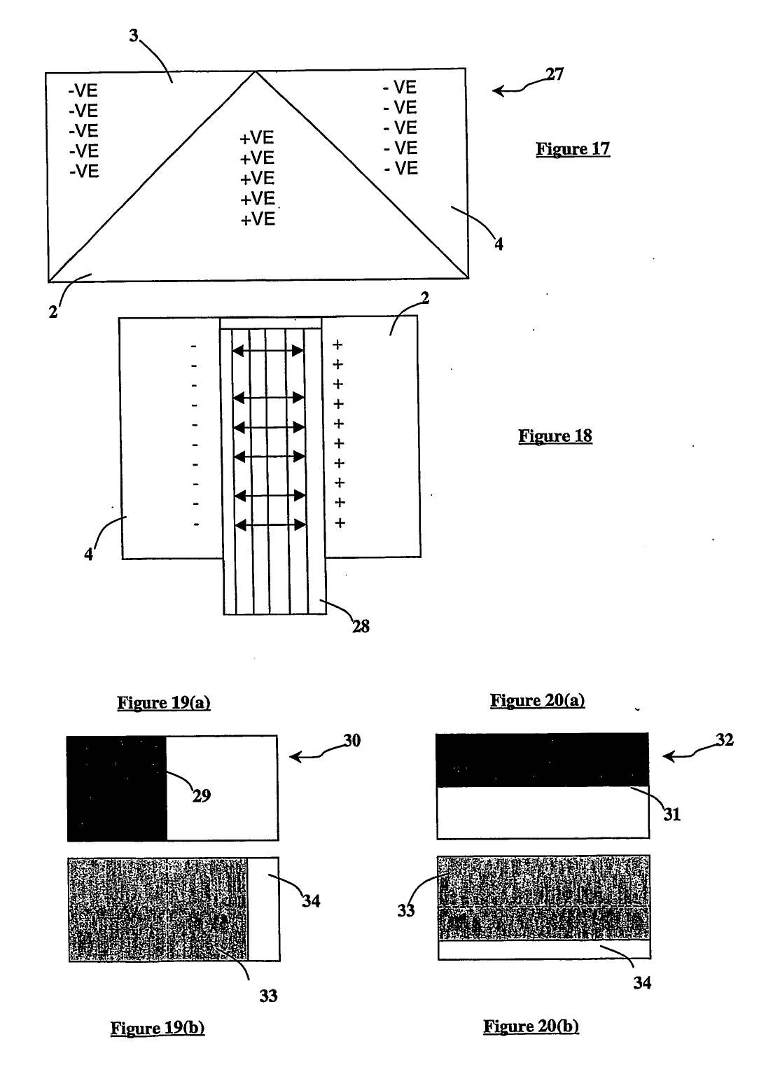

FIG. 17 is a reverse view of a fastener employing upon electrostatic attraction;

FIG. 18 is a sectional side view of the fastener of FIG. 17, in use fastening together a group of sheets;

FIGS. 19(a) and 19(b) are front and reverse view respectively of an oblong fastener having a single fold line parallel to a short side of the oblong; and

FIGS. 20(a) and 20(b) are front and reverse view respectively of an oblong fastener having a single fold line parallel to a long side of the oblong.

FIG. 21 is a front or top view of a fastener according to another embodiment of the invention showing the fastener applied to a corner of the uppermost sheet of the group and in which the fastener has an enlarged rectangular anchor portion;

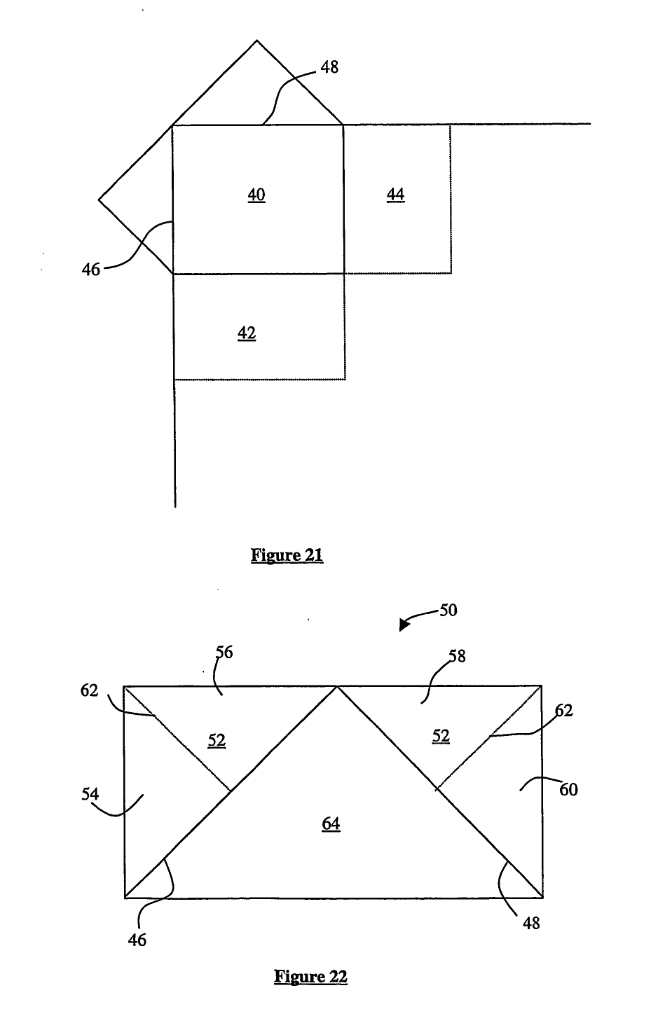

FIG. 22 is a front or top view of a fastener in accordance with a further embodiment of the invention in which the triangular tab portions are segmented;

FIG. 23 is a front or top view that follows on from FIG. 22 and shows the fastener applied to a corner of the uppermost sheet of the group, prior to the segments being folded around sheets of the group;

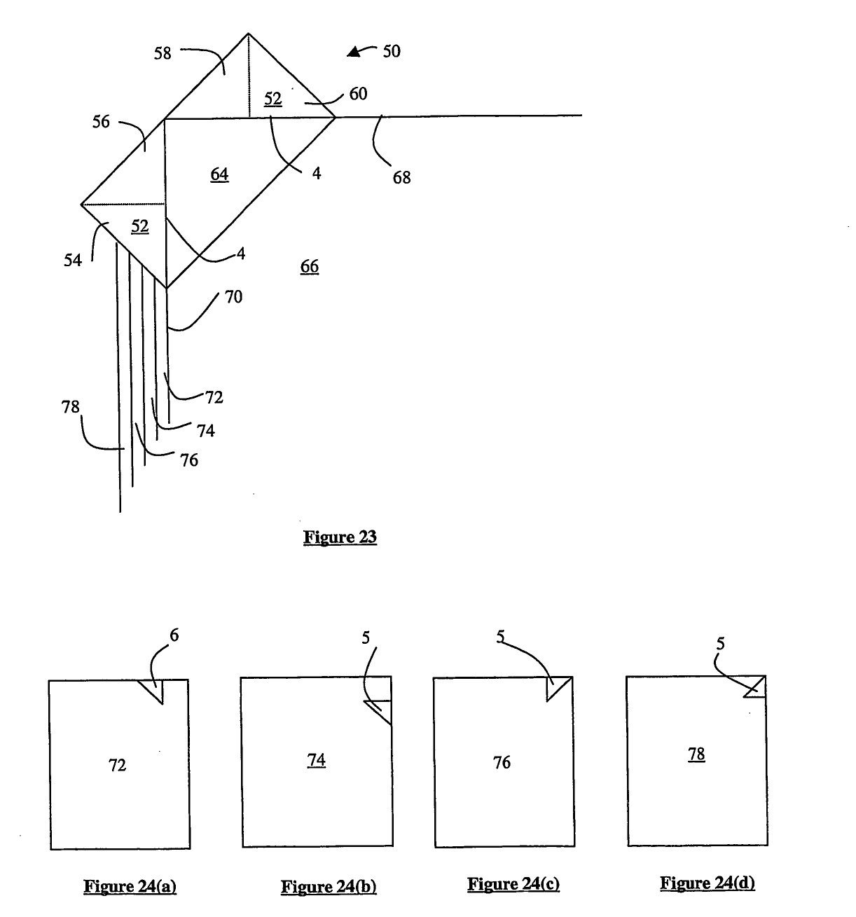

FIGS. 24(a) to 24(d) are reverse views of sheets of the group in FIG. 23 with segments attached;

FIG. 25 is a front or top view of the fastener of FIG. 1 applied to the uppermost sheet of a group of documents prior to the tab portions being folded.

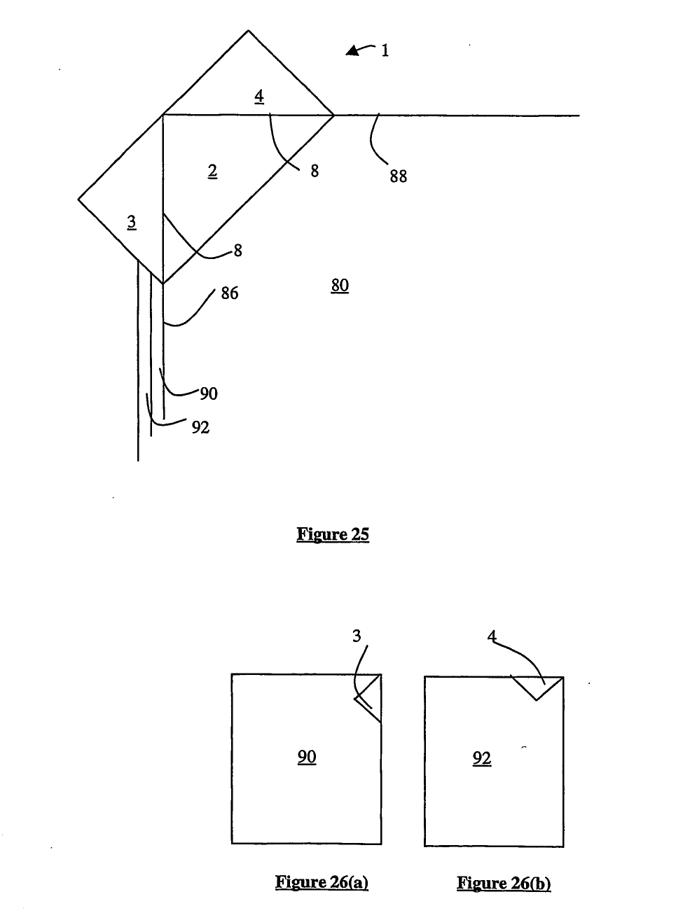

FIGS. 26(a) and 26(b) are reverse views of sheets of the group in FIG. 25 with tab portions attached.

Referring firstly to FIGS. 1 and 2 of the drawings, the fastener 1 of the invention is an adhesive-backed paper oblong that conveniently gathers and holds together two or more sheets of paper in a group. The fastener 1 has guide markings to facilitate correct positioning and folding with respect to a sheet of paper, making it a convenient and effective substitute for a staple, paper clip or other known fastener.

The preferred embodiment shown in FIGS. 1 and 2 is made from white lightweight 70 gram paper and its dimensions are 50 mm by 25 mm. As will become apparent upon further reading, these features are mentioned by way of example only. However, it is particularly preferred that even if the fastener 1 is scaled up or down, each long side of the oblong should be twice the length of each shorter side.

The front or top side of the fastener 1 shown in FIG. 1 is divided into three right-angled triangles that define fold guides and attachment means. The triangles are disposed such that a central larger right-angled triangle 2 is flanked by two smaller right-angled triangles 3, 4 inverted with respect to the larger triangle 2. The internal angles of each triangle are 90°, 45° and 45°. In the embodiment illustrated, the sides of the triangles measure 50 mm by 35 mm by 35 mm for the larger triangle 2, and 35 mm by 25 mm by 25 mm for the two smaller triangles 3, 4. Thus, the mutual boundaries between the larger triangle 2 and the two smaller triangles 3, 4 are defined by mutually orthogonal straight lines each of 35 mm in length that originate in the bottom corners of the oblong and intersect mid-way along the opposite long edge of the oblong.

Whilst the fastener 1 as a whole may be scaled up or down, it is envisaged that this ratio of triangle sizes can remain constant for all fastener sizes.

The triangles 2, 3, 4 defining the fold guide zones can be shaded, coloured or otherwise marked to distinguish one from another, and their boundaries can be defined in various ways. In this instance, the two smaller triangles 3, 4 are shaded in a contrasting colour to the larger central triangle 2 and the mutual boundaries between the small and large triangles are denoted by the contrast between the triangles 2, 3, 4. The larger triangle 2 may incorporate a watermark (not shown), which is suitably aligned to be presented in an upright orientation with respect to a fastened group of papers once the fastener has been positioned for use, but is effectively left white or natural to allow users to write notes upon it. However, as will be made clear, some variants can be coloured completely, whereas others might only be coloured on the larger triangle 2. It would also be possible to rely upon marked lines to denote the mutual boundaries between the small and large triangles 2, 3, 4.

Turning now to FIG. 2 which shows the rear, reverse or bottom side of the fastener 1, this can be marked in much the same way as the front of the fastener 1 but is preferably left plain, hence adopting the colour of whatever paper is used. However, this side bears a layer of tacky, repositional adhesive 5 that extends continuously along the full length of the fastener 1 and from one long edge at the top of the oblong to most, but not all, of the way across its width towards the other long edge at the bottom of the oblong. In the preferred embodiment shown, the adhesive layer 5 is an oblong of 50 mm by 20 mm leaving an oblong strip 6 of 5 mm by 50 mm without adhesive extending along the bottom long edge of the oblong defining the fastener 1. This strip 6 acts as a lift tab to facilitate removal of a fastener 1 from a pad of such fasteners as will be explained, or from a sheet of paper if it is desired to remove or reposition the fastener 1.

The shape and size of the adhesive layer 5 can be varied in accordance with the size of the fastener 1, the nature of the adhesive used and the number, size or weight of sheets that the fastener 1 is intended to fasten. Also, it is not essential that the layer of adhesive 5 is continuous across all portions of the fastener 1.

The fastener 1 of the invention is used by gathering and aligning a group 7 of paper sheets 8, 9, 10 as shown in FIG. 3 and then placing the adhesive side of the fastener 1 face down at the corner of the uppermost paper sheet 8 in the gathered group as shown in FIG. 4. The fastener 1 is oriented with respect to the sheet 8 so as to align the boundaries of the guide triangles 2, 3, 4 with the edges of the sheet 8 that intersect at that corner. This places the right-angled corner of the large triangle 2 attached to the corner of the sheet 8 as an anchor portion and leaves the smaller triangles 3, 4 as flaps or tabs overhanging the edges of the sheet 8. Then, the smaller triangles 3, 4 are folded tightly around the edges of the sheet 8 around the back of the gathered group 7 as shown in FIG. 5 and finally are sealed flat against the underside of the lowermost sheet 10 of the group 7, as shown in FIG. 6. The neat appearance of the fastener 1 viewed from the front of the gathered group 7 is evident from FIG. 7.

Although not essential to secure fixing, FIG. 6 shows that perfect alignment of the fastener with respect to the gathered group of sheets will lead to the small triangles 3, 4 abutting each other at the back of the group 7 to create a large triangle that emulates the large triangle 2 at the front of the group 7.

A single fastener 1 will be most effective at gathering and holding together a group of between two and five sheets of paper of up to A3 size. If more or larger sheets of paper are to be gathered, an additional fastener 1 can be applied to another, preferably opposite corner of the group to ensure that all of the sheets remain grouped.

In some variants, the fastener may be further distinguished by fold adaptations such as crease lines in its rear or bottom side that follow the mutual boundaries between the triangles. The crease lines may vary in depth and diameter but are incorporated to aid accurate and speedy folding of the fastener 1 around a group of gathered documents. It is envisaged that these crease lines will increase or decrease in length, depth and diameter proportionately to suit different sizes of fastener.

It is contemplated that the fastener will be supplied as one of a pad of say fifty or a hundred of such fasteners releasably adhered to each other in the manner of notelets sold by 3M™ under the registered trade mark Post-It. A fastener is made ready for use simply by peeling it from the fastener pad.

The fastener of the invention is an effective substitute for many conventional paper fasteners and provides numerous benefits. For example, the fastener obviates staples and other fasteners requiring special tools for their application and removal. There are no moving parts prone to malfunction, ensuring a high perception of quality. Moreover, the fastener will not leave unsightly marks, tears or blemishes on gathered sheets. Consequently, photocopied, scanned or faxed counterparts to the fastened documents will look clean and professional without staple holes or other markings. Indeed, simple removal of the fastener allows a user easily to remove sheets for copying, scanning or faxing without the need for a staple extractor, without risking damage to fingers or fingernails.

In general, the ergonomic design of the fastener means that it need only be gripped between a finger and thumb in use and so can be used by anyone who has reasonable dexterity, without prior knowledge or training. Moreover, the fastener is extremely safe to use with negligible potential for causing injury, and is therefore appropriate for use by young children and the elderly.

The adhesive properties of the fastener mean that, unlike a paper clip, the fastener is unlikely to slip off a gathered group of sheets: it needs to be deliberately peeled off. Also unlike a paper clip, the fastener cannot stretch and deform in a manner prejudicing its ability to grip; moreover, its flat profile and adhesive attachment means that it is unlikely to be snagged and hence accidentally peeled off.

Even if inadvertently left attached to a sheet of paper when copying, scanning or faxing, the flexibility of the fastener avoids the damage to expensive equipment that is commonly suffered where staples or other fastenings have not been completely removed from a sheet before such operations.

The fastener of the invention can be used as a substitute for a conventional ring-binder file by gathering the sheets together for flat storage. By eliminating the need for a hole punch and ring-binder, the documents remain clean and unspoiled for future presentation or duplication. Moreover, the fastener's properties lend it to conventional file storage, especially where documents are stored horizontally and space is a premium, and where speedy identification is of benefit. The fastener's flat profile and adhesive bond to the underlying sheet minimises the additional thickness of the gathered group, meaning that more documents can be stored in the same space. Also, as each fastener can be colour coded, a group of documents can be quickly identified and reviewed, removed or added to, aided by quick and simple removal and application of the fastener without the need for additional equipment. The documents can be re-gathered using the same fastener or a new one, and returned to storage.

As the fastener of the invention is preferably made of standard paper, its profile when fixed to a group of sheets adds less than 0.5 mm to the thickness of that group. This is of particular benefit where groups are required for stacking, filing or mailing because the thickness of the group at one end or side will not be significantly greater than at the other end or side, therefore leaving a stack of such groups relatively balanced. Filing and mailing issues are also eased.

Similarly, the fastener of the invention sits neatly over one or more corners of the gathered group of sheets and does not add significantly to the area of the sheets, thus avoiding storage problems. Moreover, the neatness and symmetry of the fastener in use avoids attracting attention away from the documents that make up the group of sheets.

The fastener of the invention can provide an area for writing notes or initials which, on removal of the fastener, leave the gathered documents unmarked. Unless and until the fastener is deliberately removed, the gathered documents can be circulated while ensuring that information carried by the fastener is passed on with the documents. More generally, the design of the fastener provides a selection of zones to be personalised, coded, categorised or branded for individuals or companies.

A pad of fasteners in accordance with the invention is compact and will fit conveniently on or in any desktop, shelf or drawer. The user can quickly access the pad without the need for specialist storage or dispensers, although the use of such storage or dispensers is not precluded by the invention.

Due to its repositional adhesive, a single fastener can be used several times yet due to its cheapness, the fastener can be discarded when no longer needed.

It is currently preferred that the fastener of the invention will employ 3M™ ReMount™ Repositional Adhesive. However alternative adhesives or product substitutes may be used instead. These include, by way of example: 3M™ Repositional Adhesive 75; 3M™ Spray Mount™ Artists Adhesive (6064/6065) MSDS (Material Safety Data Sheets) 0775288; 3M™ Photo Mount™ Spray Adhesive (6089/6090/6094) MSDS 1662485; 3M™ Super77™ Spray Adhesive. MSDS 1142579; 3M™ Super77™ Multipurpose Adhesive. MSDS 1634724; 3M™ Brand Super77™ Multipurpose Adhesive.(XA-9477) MSDS 1104595; 3M™ Brand Super77™ Multipurpose Adhesive.(EC-4434X) MSDS No.'s 1089556,0871616,0871590,0871574; Scotch™ Restickable Adhesive Glue Stick, 6314; and Scotch™ Restickable Adhesive Glue Stick, 6307N.

Many other variations are possible within the inventive concept. For example, the dimensions of the fastener may vary but where the fastener is an oblong, it is preferred that the proportions of the fastener should always remain constant so that the ratio of a long side to a short side will remain at 2:1. The fastener size may decrease or increase accordingly through a range exemplified by 10 mm:5 mm; 20 mm:10 mm; 30 mm:15 mm; 40 mm:20 mm; 60 mm:30 mm; 70 mm:35 mm; 80 mm:40 mm; 90 mm:45 mm; 100 mm:50 mm; and 210 mm:105 mm. Differently-sized fasteners are shown superimposed in FIG. 8 of the drawings, by way of illustration.

As mentioned at the outset in relation to FIG. 1, respective portions of the fastener 1 may be identified by a contrast in shading between the two triangular outer tabs 3, 4 and the central anchor portion 2. Shading can of course be varied: by way of example, FIGS. 9(a) and 9(b) show two fasteners, that in FIG. 9(a) showing a fastener 11 with the central portion 2 of lighter shade than the outer tabs and FIG. 9(b) showing a fastener 12 with the central portion 2 of darker shade than the outer tabs 3, 4.

Colour, too, may play a part in the function and appearance of the fastener 1: indeed any combination of colour or monochrome may be used, as can phosphorescent and fluorescent colours so that documents can be identified in poor light, or for the purpose of personalised security markings. Colouring might be achieved through the use of coloured paper, a standard colour print dye or a coating such as foils to create metallic finishes. The colour palette might also include a combination of coloured central anchor portions and non-coloured outer tabs or, conversely, coloured tabs and a non-coloured (i.e. white or natural) anchor portion. Alternatively, all portions of the fastener 1 may be the same colour if the fold lines are suitably marked.

The description relating to FIG. 1 mentioned the optional use of a solid line to designate the fold line. Such a line may also or alternatively be coloured, dashed, perforated, creased or scored. Perforated lines 13 and scored lines 14 are shown in FIGS. 10 and 11 respectively and have the advantage of locally increasing the flexibility of the fastener material along the fold lines. This eases location of the central anchor portion 2 with respect to the uppermost sheet of a gathered group of papers and also eases folding of the outer tabs 3, 4 around the edges of the group.

The score line 14 in FIG. 11 is a machined indented crease on the reverse side of the fastener 15 whose cross-section is as shown in the enlarged detail view in that Figure. The depth, width and cross-sectional shape of the crease many vary. For example, the width of the crease may be greater to suit a thicker group of papers and/or a correspondingly larger fastener. It is currently envisaged that the crease width could be enlarged in increments of 2 mm up to a maximum of 25 mm, depending upon the size of the fastener and the number of sheets it is expected to fasten together. The following table illustrates this relationship

| fastener size | | crease width |
|---|---|---|
| 10 mm: 5 mm | | <1 mm |
| 20 mm: 10 mm | | 1 mm-2 mm |
| 30 mm: 15 mm | | 1 mm-2 mm |
| 40 mm: 20 mm | | 1 mm-2 mm |
| | up through | |
| 60 mm: 30 mm | | 1 mm-2 mm |
| 70 mm: 35 mm | | 2 mm-4 mm |
| 80 mm: 40 mm | | 4 mm-8 mm |
| 90 mm: 45 mm | | 8 mm-15 mm |
| 100 mm: 50 mm | | 10 mm-25 mm |

As a further optional measure shown in FIG. 12, the fastener 16 can incorporate bands 17 of a stronger adhesive which may be applied along and across the increased fold area. FIG. 12 shows such an arrangement, which has the advantage of improved adhesion to the edges of sheets in the group without compromising the main fastener characteristics of removability and replaceability assured by the weaker adhesive that contacts the faces of the sheets.

A further modification of the invention is shown in FIG. 13 which shows a fastener 18 having a small triangular notch 19 positioned at the intersection of the two fold lines 20, 21, best seen in the enlarged detail view in that Figure. The purpose of this notch 19 is to assist folding around the right-angled corner of a gathered group of sheets allowing a small margin for inaccurate folding without impeding the functionality of the fastener 18. FIG. 14 shows this modified fastener 18 in use fastening together a group of sheets 22, where it will be noted that the apex 23 of the corner of the group 22 protrudes through the opening defined by the notch 19.

The benefits of the notched embodiment shown in FIGS. 13 and 14 may also be enjoyed by other embodiments (not illustrated) in which projections or extensions of the fold lines intersect at a point outside the periphery of the fastener, rather than at the periphery itself. A notch need not necessarily be provided to achieve this geometry because the fold lines will be spaced apart where they intersect the edge of the fastener. The result would be that when such a fastener is in use, it defines an inclined band around a corner of the gathered group of sheets and, like the notched embodiment, exposes the apex of that corner.

FIGS. 15 and 16 illustrate the concept of a personalised fastener 24, in this case personalised with the initials 25 of a user, one initial 25 being marked on each outer tab 3, 4. Comparison of FIGS. 15 and 16 will show that the initials 25 are oriented on the front of the tabs 3, 4 so that they align and read correctly when the fastener 24 has been applied to a group 26 of documents and the tabs 3, 4 folded around the back of the group 26 and beside one another, as shown in the rear view of FIG. 16. It would of course be possible to apply initials or other personalisation to the central anchor portion 2 of the fastener 24, either additionally or in the alternative.

It is even possible, in some embodiments of the invention, to do away with adhesives or to supplement adhesives by other means. For example, magnetic pads on the reverse of the outer tabs and the central anchor portion could be used which attract each other through the group of papers and hence clamp together the sheets of the group without recourse to adhesives. The material from which the fastener is made could also be inherently magnetic. A similar effect can be obtained by electrostatic means such as charged particles within the paper and/or the adhesive, in which the central anchor portion 2 and the tabs 3, 4 of a fastener 27 bear opposing charges, for example as shown in FIG. 17 of the drawings. The result, when the fastener 27 is folded in use as aforesaid, is that the positively-charged and negatively-charged parts of the fastener 27 sandwich a group of sheets 28 between them. An attractive force acts through the gathered sheets 28 to hold them fast, as shown in FIG. 18.

As described above, the design of the fastener provides a selection of zones to be personalised, coded, categorised or branded for individual or companies as well as providing an area to write note which, on removal of the fastener, leave the gathered documents unmarked. In a further alternative embodiment, the anchor portion may be extended to provide an enlarged area to carry written or printed information, a circulation list for example.

As shown in FIG. 21, an enlarged zone 40 is formed by the anchor portion being of rectangular (in this case square) rather than triangular shape. Alternatively, the anchor portion may be further enlarged to form a second enlarged zone (exemplified by zones 42 and 44 shown in dotted lines) by extending the anchor portion beyond at least one of its boundaries 46, 48. Indeed, whilst the enlarged anchor portions shown in FIG. 21 are rectangular, this shape is merely preferred and is not essential. For example it would be possible for the anchor portion to have a boundary of any shape, even a curved or irregular shape, between its rectilinear and mutually orthogonal boundaries necessary to align with the corner of a sheet.

Although the above described embodiments allow a plurality of sheets to be held secure through the use of a relatively strong adhesive applied along and across the fold area to adhere to the edges of the sheets, circumstances may require a plurality of sheets to be held more firmly in a group in order to minimise the risk of one or more sheets being dislodged from the group. To this end, FIG. 22 shows a fastener 50 whose tabs 52 are divided into segments 54, 56, 58, 60 by pre-cut slits or alternatively lines of weakness such as lines of perforations 62 which may be torn by a user to create the segments as required. In the embodiment shown in FIG. 22, the slits or lines of weakness 62 originate from the top corners of the fastener 50 as illustrated and intersect the mutual boundaries 46, 48 between the central triangular anchor portion 64 and the two tabs 52 orthogonally mid-way along their lengths. The slits or lines of weakness 62 together with the mutual boundaries 46, 48 therefore define the four segments 54, 56, 58 and 60 which are themselves right-angled triangles.

The fastener 50 of the embodiment shown in FIG. 22 may be employed to secure a group of up to five sheets, with each sheet being connected adhesively to each other via the fastener 50. In this case the fastener 50 is used by placing the adhesive side of the anchor portion 64 face down on the uppermost sheet 66 of the group as shown in FIG. 23. The fastener 50 is oriented with respect to the uppermost sheet 66 so as to align the mutual boundaries 46, 48 between the anchor portion 64 and the tabs 52 with the edges 68, 70 of the sheet 66 that intersect at the corner being fastened so leaving the tabs 52 overhanging the edges 68, 70.

To secure a second sheet 72, the segment 60 of the upper tab 52 as shown is folded over the top edge 68 of the first sheet 66 and secured on the reverse side of the second sheet 72 as shown in FIG. 24(a). Once the second sheet is fastened in this way, a third sheet 74 is aligned with the first two sheets 66, 72 and segment 54 of the side tab 52 as shown is folded over the side edge 70 to secure the third sheet 74, as shown in FIG. 24(b). Likewise, a fourth sheet 76 is brought into alignment with the first three sheets 66, 72, 74 and segment 58 of the upper tab 52 as shown is folded over the top edge 68 of the group to secure the fourth sheet 76 to the group, as shown in FIG. 24(c). Finally, a fifth sheet 78 is bought into alignment with the first four sheets 66, 72, 74, 76 and the final segment 56 of the side tab 52 as shown is folded around the side edge 70 of the group to secure the fifth sheet 78 to the group, as shown in FIG. 24(d). It is also possible to secure, for example, nine sheets by repeating the same process with a second fastener 50 anchored to the ninth sheet of the group and attached successively in similar fashion to the eighth, seventh, sixth and fifth sheets.

It will be apparent to the skilled reader that the fastener of the invention may be adapted by creating further or fewer tab segments to secure an appropriate number of sheets in a group using a method analogous to that described above. For instance, it is possible positively to secure a group of three sheets using a fastener with two tabs as shown above for example in FIG. 1. That is to say, each of the three sheets are adhesively connected to each other via the fastener 1 of FIG. 1. The technique for doing this is shown in FIGS. 25, 26(a) and 26(b).

As shown in FIG. 25, the fastener 1 is used by placing the adhesive side of the anchor portion 2 face down on the uppermost sheet 80 of the group. As in the previous example, the fastener 1 is oriented with respect to the uppermost sheet 80 so as to align the mutual boundaries 82, 84 between the anchor portion 2 and the tabs 3, 4 with the edges 86, 88 of the sheet 80 that intersect at the corner being fastened so leaving the tabs 3, 4 overhanging the edges 86, 88. To secure a second sheet 90, the side tab 3 as shown is folded over the side edge 86 of the first sheet 80 and secured on the reverse side of the second sheet 90 as shown in FIG. 26(a). Once the second sheet is fastened in this way, a third sheet 92 is aligned with the first two sheets 80, 90 and top tab 4 as shown is folded over the top edge 88 of the first sheet 80 and secured on the reverse side of the third sheet 92 as shown in FIG. 26(b).

Finally, aspects of the invention envisage fastener shapes other than oblongs, including but not limited to triangles, rhomboids, circles and semi-circles, and fasteners that merely gather the sheets along one edge in the manner of a hinge rather than acting as a pocket that gathers intersecting edges at a corner. A single straight fold line can be used for this purpose and this can extend along any axis of the fastener, for example the fold line 29 parallel to the short edge of an oblong as shown in the fastener 30 of FIG. 19(a) or the fold line 31 parallel to the long edge of an oblong as shown in the fastener 32 of FIG. 20(a). FIGS. 19(b) and 20(b) show the corresponding reverse views of the fasteners 30, 32 in FIGS. 19(a) and 20(a) respectively, illustrating how each fastener 30, 32 has an adhesive layer 33 covering most of its rear surface. However, it will be noted that a non-adhesive strip 34 remains along one edge of each oblong, suitably parallel to the fold lines 29, 31 to ease application, removal and repositioning of the fasteners 30, 32.

Many other variations are possible within the inventive concept. Accordingly, reference should be made to the claims and other conceptual statements herein rather than the foregoing specific description in determining the scope of the invention.

1-28. (canceled)

29. A fastener for holding together a group of documents, comprising:
a foldable sheet including first and second mutually orthogonal fold lines intersecting at an edge of the sheet to divide the sheet into a central anchor portion and first and second outer tab portions; and
a repositional adhesive adapted to attach the portions to at least a first document and a last document of the group;
wherein the first and second fold lines are adapted to align with mutually orthogonal edges at a corner of the grouped documents upon attachment of the anchor portion to the first document in the group prior to folding the first and second outer tab portions around the edges; and
wherein the outer tab portions are configured to substantially abut, when the outer tab portions are folded around the edges, upon attachment to the last document in the group to lie flat against the last document.

30. The fastener according to claim 29, wherein the adhesive includes a layer on one side of the sheet.

31. The fastener according to claim 30, wherein a minor edge portion of the side of the sheet is non-adhesive.

32. The fastener according to claim 29, wherein the anchor portion and the tab portions have one of (a) different shading and (b) different coloring.

33. The fastener according to claim 29, wherein a mutual boundary between the anchor portion and the tab portions is marked by one of (a) a printed line, (b) a line of perforations and (c) a crease line.

34. The fastener according to claim 33, wherein the boundary is marked by a crease line and wherein a relatively strong adhesive with respect to the remaining adhesive extends along and across the crease line.

35. The fastener according to claim 30, wherein a notch extends inwardly from the edge of the sheet in the region of the intersection.

36. The fastener according to claim 29, wherein the sheet is oblong.

37. The fastener according to claim 36, wherein a ratio of long edges to short edges of the oblong is 2:1.

38. The fastener according to claim 36, wherein the fold lines divide the sheet into a central triangular anchor portion flanked by two outer triangular tab portions inverted with respect to the central triangular anchor portion.

39. The fastener according to claim 38, wherein the tab portions are adapted to cooperate to form a triangle on a reverse of the last document corresponding to the central triangular anchor portion attached to the first document of the group when the tab portions substantially abut upon attachment to the last document of the group.

40. The fastener according to claim 29, wherein the central anchor portion is defined by the mutually orthogonal fold lines and at least one edge joining outer ends of the fold lines.

41. The fastener according to claim 40, wherein the edge includes two mutually orthogonal sides opposing the fold lines.

42. The fastener according to claim 41, wherein each of the sides is parallel to an opposing one of the fold lines to define a central rectangular anchor portion.

43. The fastener according to claim 40, wherein the at least one edge is one of (a) curved and (b) irregular.

44. The fastener according to claim 40, wherein at least one border of the anchor portion includes an extension of a mutual boundary between the anchor portion and an outer tab portion.

45. The fastener according to claim 29, further comprising one of (a) graphical matter and (b) indicia divided into components borne by respective ones of first and second tab portions, the components adapted to be united to be viewed together when the tab portions are attached to the last document of the group.

46. A fastener for holding together a group of documents, comprising:
a foldable sheet including first and second mutually orthogonal fold lines, extensions the first and second fold lines adapted to intersect outside a periphery of the sheet to divide the sheet into a central anchor portion and first and second outer tab portions; and
a repositional adhesive adapted to attach the portions to at least a first document and a last document of the group;
wherein the first and second fold lines are adapted to align with mutually orthogonal edges at a corner of the grouped documents upon attachment of the anchor portion to the first document in the group prior to folding the first and second outer tab portions around the edges; and
wherein the outer tab portions are adapted to substantially abut, when the outer tab portions are folded around the edges, upon attachment to the last document in the group to lie flat against the last document.

47. The fastener according to claim 46, wherein the adhesive includes a layer on one side of the sheet.

48. A pad, comprising:
a plurality of fasteners adapted to hold together a group of documents, each fastener including:
a foldable sheet including first and second mutually orthogonal fold lines intersecting at an edge of the sheet to divide the sheet into a central anchor portion and first and second outer tab portions; and
a repositional adhesive adapted to attach the portions to at least a first document and a last document of the group;
wherein the first and second fold lines are adapted to align with mutually orthogonal edges at a corner of the grouped documents upon attachment of the anchor portion to the first document in the group prior to folding the first and second outer tab portions around the edges; and
wherein the outer tab portions are configured to substantially abut, when the outer tab portions are folded around the edges, upon attachment to the last document in the group to lie flat against the last document.

49. A fastener for holding together a group of documents, comprising:
a foldable sheet including first and second mutually orthogonal fold lines which divide the sheet into a central anchor portion and first and second outer tab portions foldable around mutually orthogonal edges at a corner of the grouped documents; and
a repositional adhesive adapted to attach the portions to at least a first document and a last document of the group upon being folded around an edge of the group;
wherein at least one of the outer tab portions is divided into at least two segments, each segment foldable around one of the mutually orthogonal edges of the group to attach to a respective document in the group.

50. The fastener according to claim 49, wherein the anchor portion and the tab portions have one of (a) different shading and (b) different coloring.

51. The fastener according to claim 49, wherein a mutual boundary between the anchor portion and the tab portions includes one of (a) a printed line, (b) a line of perforations and (c) a crease line.

52. The fastener according to claim 49, wherein the first and second fold lines intersect at an edge of the sheet.

53. The fastener according to claim 49, wherein the fold lines divide the sheet into a central anchor portion flanked by two outer triangular portions inverted with respect to the central triangular portion, and wherein the central anchor portion is defined by the mutually orthogonal fold lines and at least one edge joining outer ends of the fold lines.

54. A pad, comprising:
a plurality of fasteners adapted to hold together a group of documents, each fastener including:
a foldable sheet including first and second mutually orthogonal fold lines which divide the sheet into a central anchor portion and first and second outer tab portions foldable around mutually orthogonal edges at a corner of the grouped documents; and
a repositional adhesive adapted to attach the portions to at least a first document and a last document of the group upon being folded around an edge of the group;
wherein at least one of the outer tab portions is divided into at least two segments, each segment foldable around one of the mutually orthogonal edges of the group to attach to a respective document in the group.

55. A method of fastening a group of documents with a fastener, the fastener including a foldable sheet including first and second mutually orthogonal fold lines which divide the sheet into a central anchor portion and first and second outer tab portions foldable around mutually orthogonal edges at a corner of the grouped documents, and repositional adhesive adapted to attach the portions to at least a first document and a last document of the group upon being folded around an edge of the group, at least one of the outer tab portions divided into at least two segments, each segment foldable around one of the mutually orthogonal edges of the group to attach to a respective document in the group, comprising:
aligning the first and second fold lines of the fastener with the edges of the first document of the group in a corner to be fastened;
attaching the anchor portion of the fastener to the first document;
adding a second document to the group in alignment with the first document;
folding a first tab portion of the fastener around an associated edge of the group and attaching the first tab portion to the second document;
adding a third document to the group in alignment with the first and second documents;
folding a second tab portion of the fastener around an associated edge of the group and attaching the second tab portion to the third document.

56. The method according to claim 55, wherein the first and second tab portions are folded in the folding steps around different edges of the group.

57. The method according to claim 55, further comprising attaching the segments of a tab portion to respective different documents of the group.
